(19) United States
(12) Patent Application Publication
(10) Pub. No.: US 2009/0079221 A1
(43) Pub. Date: Mar. 26, 2009

(54) USER-CENTRIC SOLAR VISOR FOR VEHICLES

(76) Inventor: JAMES ELLIOTT MARSHALL, CORRALES, NM (US)

Correspondence Address: JAMES ELLIOTT MARSHALL, 651 CALLE DE BLAS, CORRLALES, NM, 87048, US

(21) Appl. No.: 11/860,563

(22) Filed: Sep. 25, 2007

(51) Int. Cl. B60J 3/02

(52) U.S. Cl. 296/97.4; 296/97.9

(57) ABSTRACT

A user-centric solar visor for vehicles comprising a relatively small visor panel (10) which, after pivoting down to an operational position, can be easily positioned in a roughly orbital path around the user (hence “user-centric”), extended up or down, and pivoted about its center to safely block any problematic direct or reflected solar light. One embodiment of user-centric manipulation of the visor is accomplished by a pivoting horizontal extension bar (24) mounted to the roof of the vehicle in the general vicinity of the user's head. In addition to use as original equipment, the embodiment may be installed as a replacement visor by the use of an adaptor extension arm (42) and an adaptor bracket (44). One alternate embodiment of user-centric manipulation of the visor is accomplished by a recessed visor track (64) attached to the roof of the vehicle describing an arc approximately centered about the user's head.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

This invention generally relates to solar visors for vehicles, specifically to such visors which are permanently and adjustably mounted interior to the passenger cabin.

2. Prior Art

All vehicle manufacturers provide solar visors in vehicles intended for use on public roads. These visors are of various designs and sizes. However, virtually all visors are attached to the vehicles at a point between the windshield and the side windows with a pivoting means to provide solar screening for both the windshield and the side windows. Additionally, these visors pivot up and down allowing varying degrees of shielding and allowing the visors to be stowed flat against the roof of the vehicle.

Unfortunately, these visors move in an arc that conflicts with the user's head, causing the user to duck or lean to the side while manipulating the visor from windshield to side window or vice versa. This usually occurs while the user is trying to negotiate a turn since turning causes the angle of the sun to change relative to the vehicle, thereby requiring the visor adjustment. Consequently the user will frequently expose their eyes directly to the sun while performing this maneuver since the visor is essentially non-functional in the intermediate positions. When the sun is at certain angles, for example toward the opposite side of the vehicle from the user, traditional visors are completely useless for screening the sun. In fact, the user will sometimes reach across the vehicle and utilize the visor intended for use by the other passenger to block these angles.

When the sun is low in the sky the traditional visor cannot screen the sun without also blocking the user's view of signage or traffic signals which are relatively higher in the sky than the sun. Shorter users have the most trouble using traditional visors because the visor cannot be sufficiently lowered to effectively screen the sun.

One response to this dilemma has been to provide sliding extensions to the visors to increase the coverage. An extreme example of this is found in U.S. Pat. No. 5,445,427 issued to Vandagriff on Aug. 29, 1995. Vandagriff discloses supplementary panels that extend out from the primary visor to increase the coverage. The problem with this is the visor is now larger and will interfere more with the user's head when swinging between windshield coverage and side window coverage, unless the user first collapses the extensions and then ducks to swing the visor around. Also, the increased size reduces the visibility of traffic, pedestrians and signage for the user.

Another variation has been to enable the visor to slide along the length of the rod on which it pivots. Again, this enables the visor to provide more coverage and again it requires sliding the visor back to the collapsed position before swinging the visor from side-to-side. Keep in mind that these convoluted, awkward motions distract the user from focusing on maintaining control of the vehicle and awareness of traffic and therefore represent a safety hazard. Add to this the distractions of cell phones, geographic positioning systems, eating while driving, and conversations within the vehicle and the safety issues become clear.

Various aftermarket products have attempted to solve some of these issues. One such variation is an additional visor that attaches to the vehicle's primary visor and either pivots or slides downward or outward to provide additional coverage. Another is a fixed position visor that attaches, usually with suction cups, to the inside of the windshield or to the side window to cover specific problem areas. Yet another can be seen in U.S. Pat. No. 5,641,191 issued to Jia on Jun. 24, 1997, which discloses a widely adjustable arm with a small visor at the end that attaches to the existing visor or to the rear view mirror bracket and utilizes telescoping sections and ball-joints to block additional sun angles. Unfortunately, the Jia visor is used independent of the vehicle's primary visor to block specific problem areas and fails to address the inherent safety problems of the primary visor. It also suffers from not having a reasonable stowed position available and thus detracts from a clean, uncluttered vehicle cabin and becomes an eyesore as well as a distraction.

U.S. Pat. No. 6,328,370 issued to Kim on Dec. 11, 2001 discloses a visor on an exposed track that extends from a position near the center of the windshield, curves around and terminates near the end of a vehicle side window. While this accomplishes the objective of avoiding conflicts with the user's head when repositioning the visor from windshield to side window, it does not address: 1) conditions when the problematic light source is entering from the far side of the window; 2) conditions when the angle of the problematic light is low; 3) operational problems for shorter users; and 4) conditions where the large visor surface obscures the visibility of traffic signage.

U.S. Pat. No. 1,791,699 issued to Ayersman on Feb. 10, 1931 discloses a glare shield comprised of a transparent screen colored to absorb certain light spectrum. The disclosed mounting assembly has similarities to the present invention. However, the mounting assembly is considerably more complex and not as readily adjustable as the present invention. It also does not address: 1) conditions when the angle of the problematic light is very low; 2) operational problems for shorter users; and 3) conditions where the large visor surface obscures the visibility of traffic signage.

U.S. Pat. No. 1,473,878 issued to Roy on Nov. 13, 1923 discloses a glare shield specified to optimally utilize a translucent material, with a linkage that appears to have some similarities to the present invention. However, note that it is intended to be mounted to the windshield frame and therefore does not pivot about the user. Therefore, the Roy patent does not address problematic light entering from the sides of the vehicle. It also depends on the windshield being located far enough away from the user's face to allow the visor to swing in an arc that literally swipes across the user's face.

Finally, U.S. Pat. No. 390,790 issued to Luce on Oct. 9, 1888 discloses a sunshade for vehicles which has some similarities to the present invention. However, the mounting assembly attaches to “one of the supports of the canopy” which indicates that the actual vertical axis pivot location is not a concern of the Luce invention. Therefore the Luce invention is not designed to be “user-centric” and, depending on the actual mounting location, will not provide adequate coverage of sun angles. It also does not address: 1) simplification of operation for ease of use; 2) conditions when the angle of the problematic light is low; 3) operational problems for shorter users; and 4) conditions where the large visor surface obscures the visibility of traffic signage.

3. Objects and Advantages

Accordingly, beside the objects and advantages of the visors described in my above patent, several objects and advantages of the present invention are:
a. to provide a visor which can be easily positioned to shield the sun or other sources of problematic light from any and all angles;
b. to provide a visor of the minimum size required to effectively block the problematic light without unnecessarily blocking views of signage, traffic and pedestrians;
c. to provide a visor which requires no complex, awkward or contorted motions;
d. to provide a visor which will address anthropometrics by being as beneficial and usable by shorter users as it is by taller users;
   thereby improving safety and reducing the incidence of accidents, injuries and fatalities related to the direct and reflected blinding effect of the sun.

### SUMMARY

In accordance with the present invention a visor device comprising a visor of a reduced size and an adjustable means of attaching to the vehicle permitting the user to easily and safely manipulate the visor into any position required to shield the user from the sun by describing an essentially orbital path centric about the user.

### DRAWINGS

### Figures

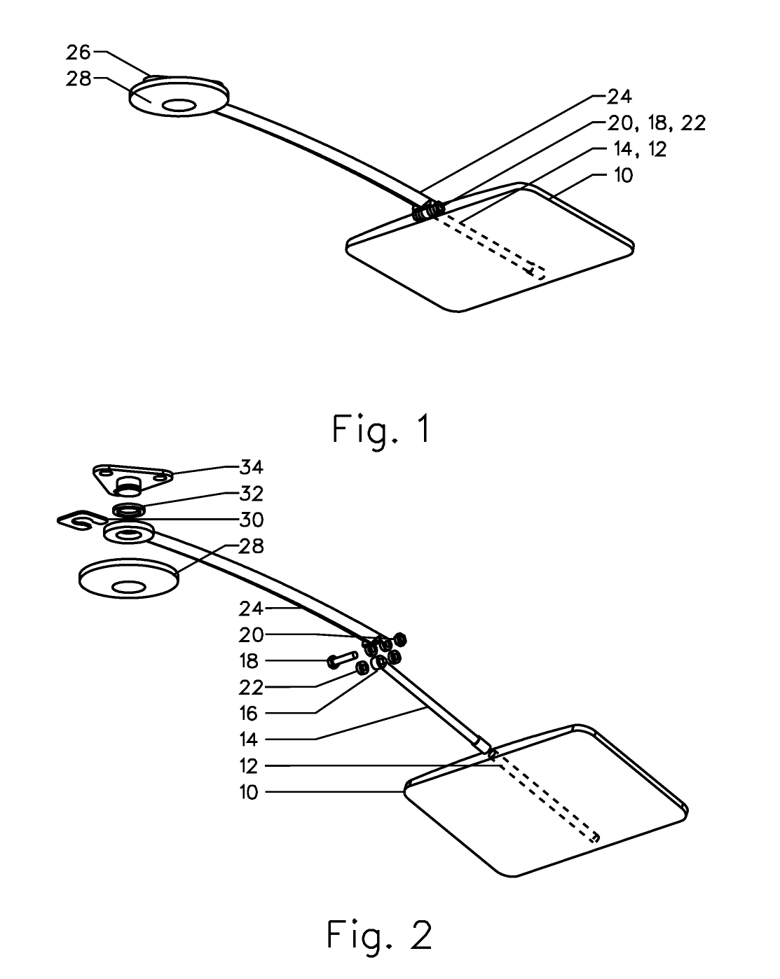

FIG. 1 shows an assembled view of the preferred embodiment of the present invention.

FIG. 2 shows an exploded assembly view of the preferred embodiment.

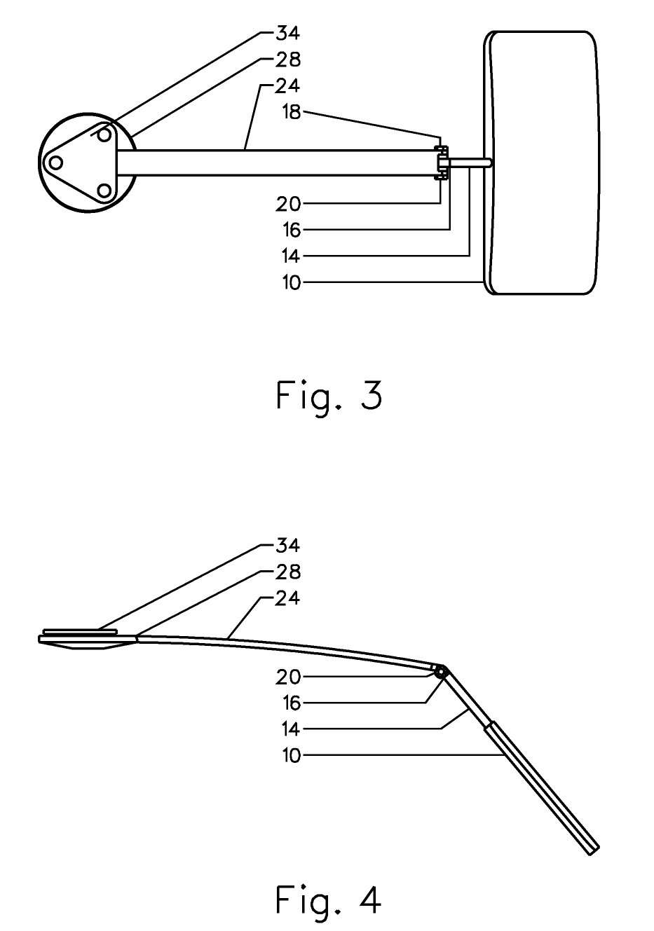

FIG. 3 shows a plan view of the preferred embodiment.

FIG. 4 shows a side elevation view of the preferred embodiment.

FIG. 5 shows the various operational movements of the preferred embodiment.

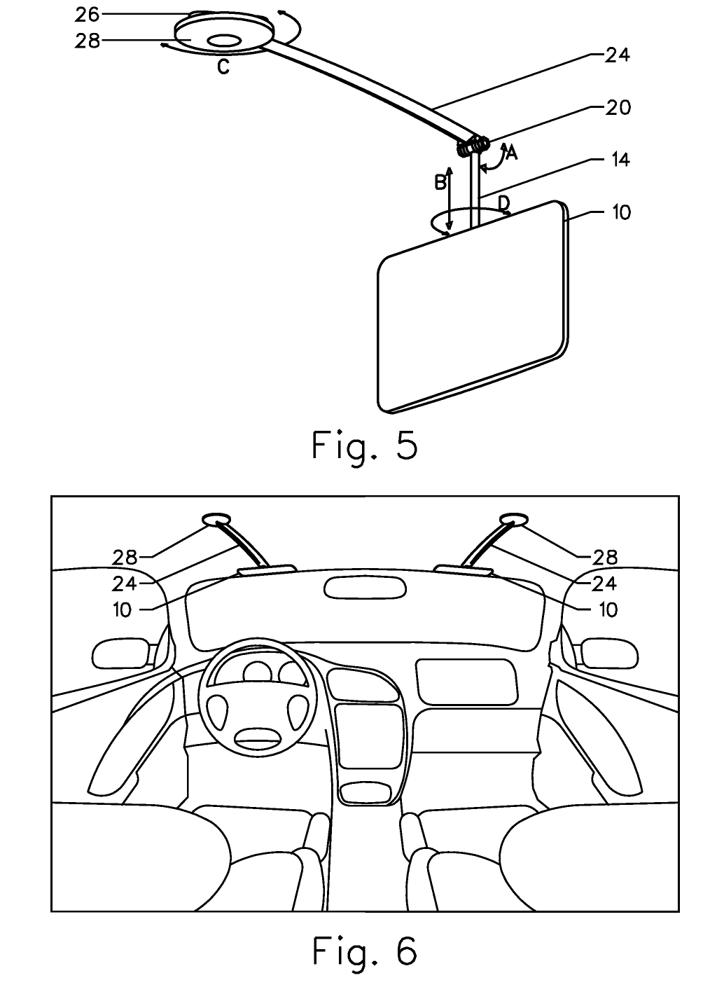

FIG. 6 shows a perspective of the preferred embodiment fully-stowed in a vehicle.

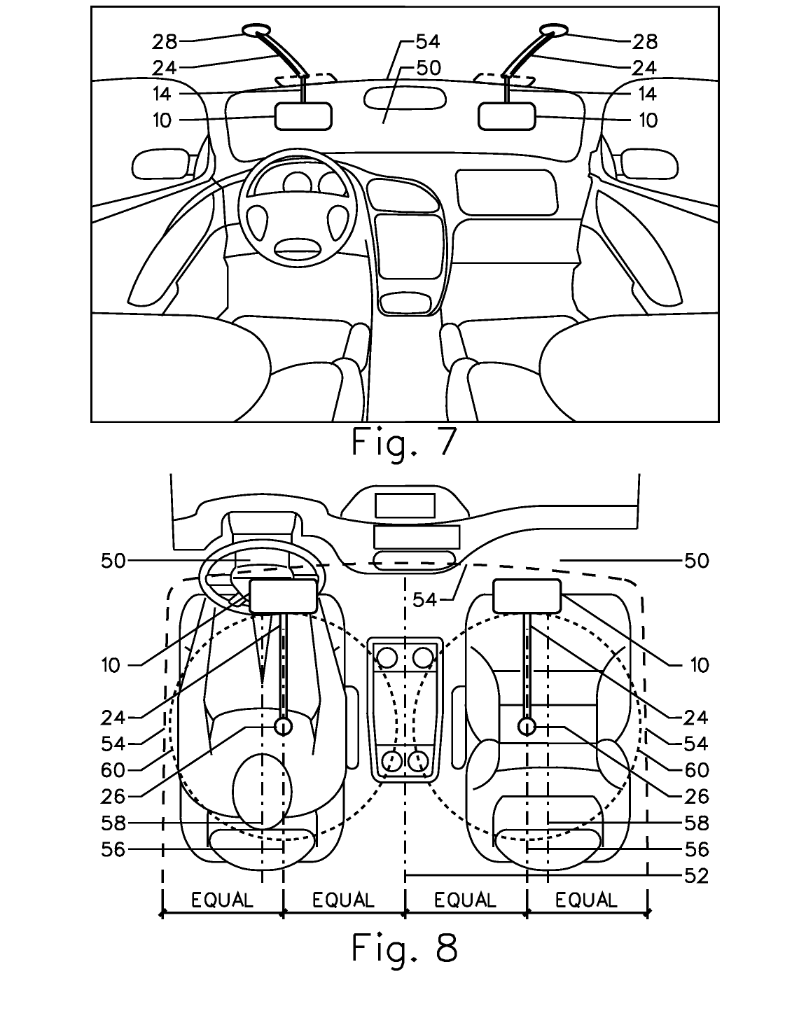

FIG. 7 shows a perspective of the preferred embodiment in a typical deployed position.

FIG. 8 shows a method for determining the pivot location and horizontal extension arm geometry within a passenger cabin.

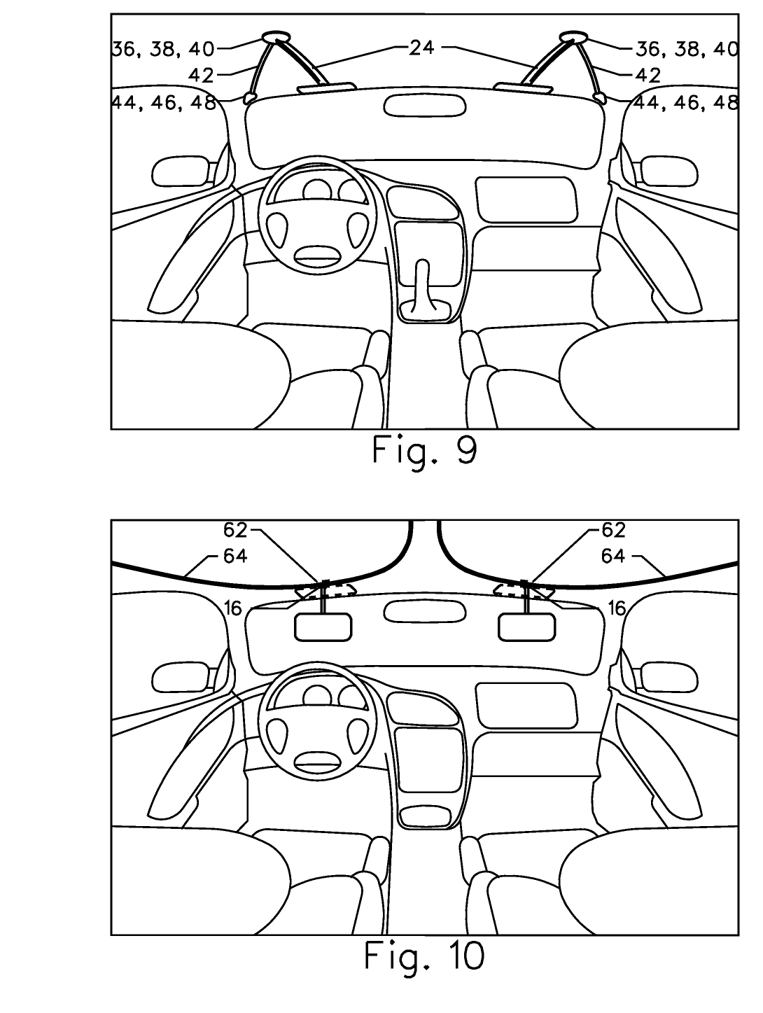

FIG. 9 shows a perspective view of an alternate embodiment of the present invention incorporating a vehicle adaptor arm for installation in an existing vehicle.

FIG. 10 shows a perspective view of an alternate embodiment of the present invention utilizing a curved track and trolley in lieu of a horizontal extension bar.

DRAWINGS-Reference Numerals

| | | | |
|---|---|---|---|
| 10 | visor panel | 12 | tubular sleeve for extension rod |
| 14 | extension/vertical pivot rod | 16 | pivot end |
| 18 | pivot axle bolt | 20 | pivot axle nut |
| 22 | pivot bushings | 24 | horizontal extension bar |
| 26 | vertical axis pivot assembly | 28 | decorative escutcheon cover |
| 30 | vertical axis retainer clip | 32 | vertical axis bushing |
| 34 | vehicle attachment bracket | 36 | adaptor pivot bolt |
| 38 | adaptor pivot bushing | 40 | adaptor pivot nut |
| 42 | adaptor extension arm | 44 | adaptor bracket |
| 46 | adaptor extension arm bolt | 48 | adaptor extension arm nut |
| 50 | windshield | 52 | vehicle centerline |
| 54 | interior vehicle roof line | 56 | pivot mounting centerline |
| 58 | seat centerline | 60 | pivot sweep arcs |
| 62 | trolley assembly | 64 | recessed visor track |

### DETAILED DESCRIPTION

### FIGS. 1, 2, 3 and 4

### Preferred Embodiment

A preferred embodiment of the visor device of the present invention is illustrated in FIG. 1 (assembled perspective view), FIG. 2 (exploded assembly view), FIG. 3 (plan view), and FIG. 4 (side elevation view). The visor device has a comparatively small visor panel 10 incorporating a tubular sleeve 12. An extension/vertical pivot rod 14 is assembled inside tubular sleeve 12 permitting visor panel 10 to both pivot rotationally about, and to slide along the length of, extension rod 14. Extension rod 14 includes a pivot end 16 attached to a horizontal extension bar 24 using a pivot axle bolt 18, a plurality of pivot bushings 22, and a pivot axle nut 20 permitting extension rod 14 to pivot upwards and downwards.

Horizontal extension bar 24 is attached to a vehicle attachment bracket 34 with a vertical axis pivot assembly 26 comprised of a vertical axis bushing 32 and a vertical axis retainer clip 30 which clips onto vehicle attachment bracket 34. Vehicle attachment bracket 34 is attached to the roof of the vehicle and a decorative escutcheon cover 28 snaps into place to conceal vehicle attachment bracket 34.

### OPERATION

### FIG. 5

The manner of using the user-centric solar visor for vehicles is similar to but simpler than visors in current use. From the stowed position, one will typically choose to first pivot visor panel 10 down into a vertical orientation, indicated by directional arrow A. One may then choose to extend visor 10 vertically to the desired height and then rotate horizontal extension bar 24 to the desired azimuth, indicated by directional arrows B and C respectively. Alternatively these last two motions may be reversed or may even be performed simultaneously. Additionally, visor panel 10 may be pivoted about its centerline for fine-tuning, indicated by directional arrow D.

While operating the vehicle, the user can easily move the visor from any position to any other position to address the location of the sun or any other problem light or glare, using only one hand and without ducking or dodging. Visor panel 10 may be extended up and down, rotated around the user, and pivoted in two other axes for fine tuning.

To return visor panel 10 to a stowed position, one will typically collapse visor panel 10 vertically along extension rod 14, followed by rotating horizontal extension bar 24 to the forward position, and finally pivoting visor panel 10 up into the stowed position.

### PREFERRED EMBODIMENT INSTALLED IN AN AUTOMOBILE

### FIGS. 6 and 7

FIGS. 6 and 7 are simply perspective views of the preferred embodiment installed in a vehicle. FIG. 6 illustrates the stowed position. FIG. 7 illustrates a common in-use extended position.

### PIVOT LOCATION AND HORIZONTAL EXTENSION ARM GEOMETRY

### FIG. 8

The preferred method for locating pivot assemblies 26 on an interior vehicle roof is shown in FIG. 8 and described in the following three steps: First, the width of an interior roof line 54 above the passengers is divided into fourths. Two pivot mounting centerlines 56 are established in approximate alignment with the two quarter points to ensure pivot sweep arcs 60 of the visors do not cross in the middle. Second, the maximum length of horizontal extension bar 24 is calculated to be slightly less than the distance from pivot centerline 56 to the interior edge of the roof above the side window. Third, the height of visor panel 10 is added to the length of horizontal extension bar 24, and pivots 26 are then located this same distance back from interior roof line 54 above the windshield 50 to permit the stowing of visor panel 10 flat against the headliner. Note that the pivot location does not need to be directly over the user's head or even in line with a seat centerline 58. Also note that depending on the user's preference for the fore and aft positioning of their seat, the main arc described by horizontal extension bar 24 can potentially conflict with the user's head if pivoted fully back toward the rear of the vehicle. This is not important because visor panel 10 should never need to be pivoted this far back to be effective.

The exact positioning of pivots 26 is ultimately affected by overall interior passenger cabin design considerations including the interior roof profiles of the vehicle. For example, to accommodate specific interior design features the arc may be limited to less than 360 degrees, the pivot locations may be adjusted closer to the side windows, and the length of horizontal extension bar 24 may be shortened. These types of design adjustments may be required to accommodate headliner mounted accessories such as map lights, sunglass holders, DVD players, etc.

This pivot positioning strategy is a key concept of the present invention. Therefore, to accommodate sunroofs and even convertibles, the pivot may need to be mounted on another assembly to maintain the positioning strategy. For a sunroof application, the vertical axis pivot assembly may be configured as an offset bracket which essentially cantilevers the pivot out into the open part of the roof. For a convertible, the pivot may be mounted on a fixed arm extending back from the windshield similar to the additional embodiment shown in FIG. 9. A more desirable option with a convertible is to mount the pivot to an existing roll-bar type structure.

### ADDITIONAL EMBODIMENTS

### FIGS. 9 and 10

The additional embodiment shown in FIG. 9 includes an adaptor for installation in an existing vehicle as a replacement for a standard visor. Horizontal extension bar 24 is attached to an adaptor extension arm 42 using an adaptor pivot assembly consisting of an adaptor pivot bolt 36, an adaptor pivot bushing 38, and an adaptor pivot nut 40, permitting horizontal extension bar 24 to pivot relative to adaptor extension arm 42. Adaptor extension arm 42 is rigidly attached to an adaptor bracket 44 using an adaptor extension arm bolt 46, and an adaptor extension arm nut 48. Adaptor bracket 44 is attached to an existing vehicle visor mounting plate using a plurality of existing vehicle visor mounting machine screws.

In the additional embodiment shown in FIG. 10, pivot end of extension rod 16 is attached to a trolley assembly 62 using pivot axle bolt 18, pivot axel bushings 22, and pivot axel nut 20. Trolley assembly 62 is comprised of a trolley body, and a plurality of trolley rollers which travel in a recessed visor track 64. Visor track 64 is a smoothly curving elliptical shape, is attached to or incorporated into the vehicle roof, and continues far enough around the operator to allow the visor to be positioned wherever the nuisance light may be coming from.

### ADVANTAGES

From the description above, a number of advantages of my user-centric solar visor for vehicles become evident:
(a) With the vastly increased flexibility in positioning this visor, a far greater ability to block the sun and other problematic light sources will exist, greatly enhancing operator and passenger safety and comfort.
(b) With this enhanced positioning ability the visor panel itself will be able to be smaller and thus will maximize the ability to maintain important sight lines, for example views of traffic signals, oncoming traffic and pedestrian crosswalks, again greatly enhancing the safety of the vehicle occupants as well as the safety of other vehicles and pedestrians.
(c) With the user-centric design of this visor allowing the user to maintain a proper driving position and posture, even while manipulating the visor, the impact of tilting one's head or ducking to avoid traditional visors will be eliminated, thus enhancing the safety of everyone in and around the vehicle.

### CONCLUSION, RAMIFICATIONS, AND SCOPE

Accordingly, the reader will see that the user-centric solar visor of this invention can be provided as original equipment or as an aftermarket enhancement in vehicles of all types, permitting an unsurpassed ability for vehicle occupants to quickly and easily deploy and position the visor in an optimal position to block nuisance light sources. Furthermore, the visor has the additional advantages in that
the size of the visor may be minimized due to the enhanced positioning capabilities, thereby obscuring a comparatively small portion of the user's field of view while blocking the nuisance light and thus enhancing safety;
the required operator movements to deploy and adjust the visor are minimal and intuitive, thereby eliminating awkward movements and thus enhancing safety; and
the enhanced positioning capabilities minimize the frequency with which the visor must be adjusted when the nuisance light is coming from certain angles that would require a standard visor to be “flipped” from front to side and back again thus enhancing safety.

Although the description above contains many specificities, these should not be construed as limiting the scope of the embodiment but as merely providing illustrations of some of the presently preferred embodiments. For example, the visor can have other shapes, such as circular, elliptical, etc.; the visor can be made of various materials including plastics, metals, fabrics, etc.; the structural elements of the attachment to the vehicle can be made of various materials including plastics, metals, etc. and may be wrapped in fabrics, plastics, rubber formulations, etc.; and the mechanism by which the visor is positioned can be accomplished with a variety of pivot assemblies, circular or elliptical guide tracks, multiply hinged arms, etc.

Thus the scope of the embodiment should be determined by the appended claims and their legal equivalents, rather than by the examples given.

I claim:

1. A solar visor for protecting vehicle operators and passengers from the dangerous effects of direct and indirect sunlight and glare, comprising:
a. a visor panel of the minimum size necessary to block problematic light such as direct sunlight and glare without unnecessarily impairing the user's general field of view, and
b. an adjustable linkage for attaching said visor panel to a vehicle while enabling the positioning of said visor panel in a substantially orbital path centric about the user,
whereby said adjustable linkage permits an operator to position said visor panel into all positions required to successfully intercept hazardous, nuisance light without excessively blocking viewing angles and without requiring potentially dangerous user movements such as ducking, leaning, excessive force and two-handed manipulation.

2. The device of claim 1, wherein said adjustable linkage includes an arm pivotably mounted to a point on the vehicle headliner substantially centered above the user's head and a rod or bar pivotably attached to the end of said arm and slidably mounted to said visor panel, whereby said visor panel may be vertically adjusted along said rod or bar while simultaneously being angularly adjusted relative to said arm and horizontally adjusted in a substantially orbital path about the user.

3. The device of claim 2, further including a telescoping component in said rod or bar permitting a greater vertical extension of said visor for the purpose of blocking lower incident light angles and for accommodating shorter operators.

4. The device of claim 2, wherein said visor panel is mirrored on one side for utilization as both a vanity mirror and as an auxiliary rearview/side view mirror for the purpose of revealing blind spots left by the standard mirrors when not in use as a solar visor.

5. The device of claim 1, wherein said adjustable linkage includes a track recessed in or surface mounted to a vehicle headliner describing a substantially orbital path about the user's head, a trolley assembly engaged by said track permitting said trolley to slide or roll along the path described by said track, and a rod or bar pivotably attached to the end of said trolley assembly and slidably mounted to said visor panel, whereby said visor panel may be vertically adjusted along said rod or bar while simultaneously being angularly adjusted relative to said trolley assembly and horizontally adjusted in a substantially orbital path about the user.

6. The device of claim 5, further including a telescoping component in said rod or bar permitting a greater vertical extension of said visor for the purpose of blocking lower incident light angles and for accommodating shorter operators.

7. The device of claim 5, wherein said visor panel is mirrored on one side for utilization as both a vanity mirror and as an auxiliary rearview/side view mirror for the purpose of revealing blind spots left by the standard mirrors when not in use as a solar visor.

8. In a solar visor of the type comprising a visor panel and an adjustable means for attaching said solar visor to a vehicle while allowing for limited positioning of said visor panel, the improvement wherein said adjustable means is designed and configured to enable virtually unlimited positioning of said visor panel in a roughly orbital path centric about the user, whereby said adjustable means permits the operator to position said visor as required to successfully intercept hazardous, nuisance light without excessively blocking viewing angles and without requiring potentially dangerous user movements such as ducking, leaning, excessive force and two-handed manipulation.

9. The device of claim 8, wherein said adjustable means includes an arm pivotably mounted to a point on the vehicle headliner substantially centered above the user's head and a rod or bar pivotably attached to the end of said arm and slidably mounted to said visor panel, whereby said visor panel may be vertically adjusted along said rod or bar while simultaneously being angularly adjusted relative to said arm and horizontally adjusted in a substantially orbital path about the user.

10. The device of claim 9, further including a telescoping component in said rod or bar permitting a greater vertical extension of said visor for the purpose of blocking lower incident light angles and for accommodating shorter operators.

11. The device of claim 9, wherein said visor panel is mirrored on one side for utilization as both a vanity mirror and as an auxiliary rearview/side view mirror for the purpose of revealing blind spots left by the standard mirrors when not in use as a solar visor.

12. The device of claim 8, wherein said adjustable linkage includes a track recessed in or surface mounted to a vehicle headliner describing a substantially orbital path about the user's head, a trolley assembly engaged by said track permitting said trolley to slide or roll along the path described by said track, and a rod or bar pivotably attached to the end of said trolley assembly and slidably mounted to said visor panel, whereby said visor panel may be vertically adjusted along said rod or bar while simultaneously being angularly adjusted relative to said trolley assembly and horizontally adjusted in a substantially orbital path about the user.

13. The device of claim 12, further including a telescoping component in said rod or bar permitting a greater vertical extension of said visor for the purpose of blocking lower incident light angles and for accommodating shorter operators.

14. The device of claim 12, wherein said visor panel is mirrored on one side for utilization as both a vanity mirror and as an auxiliary rearview/side view mirror for the purpose of revealing blind spots left by the standard mirrors when not in use as a solar visor.

15. A method of protecting vehicle operators and passengers from the dangerous effects of direct and indirect sunlight and glare, comprising:
a. a visor panel of the minimum size necessary to block problematic light such as direct sunlight and glare without unnecessarily impairing the user's general field of view, and
b. an adjustable linkage for attaching said visor panel to a vehicle while enabling the positioning of said visor panel in a substantially orbital path centric about the user,
whereby said adjustable linkage permits an operator to position said visor panel into all positions required to successfully intercept hazardous, nuisance light without excessively blocking viewing angles and without requiring potentially dangerous user movements such as ducking, leaning, excessive force and two-handed manipulation.

16. The device of claim 15, wherein said adjustable linkage includes an arm pivotably mounted to a point on the vehicle headliner substantially centered above the user's head and a rod or bar pivotably attached to the end of said arm and slidably mounted to said visor panel, whereby said visor panel may be vertically adjusted along said rod or bar while simultaneously being angularly adjusted relative to said arm and horizontally adjusted in a substantially orbital path about the user.

17. The device of claim 16, further including a telescoping component in said rod or bar permitting a greater vertical extension of said visor for the purpose of blocking lower incident light angles and for accommodating shorter operators.

18. The device of claim 16, wherein said visor panel is mirrored on one side for utilization as both a vanity mirror and as an auxiliary rearview/side view mirror for the purpose of revealing blind spots left by the standard mirrors when not in use as a solar visor.

19. The device of claim 15, wherein said adjustable linkage includes a track recessed in or surface mounted to a vehicle headliner describing a substantially orbital path about the user's head, a trolley assembly engaged by said track permitting said trolley to slide or roll along the path described by said track, and a rod or bar pivotably attached to the end of said trolley assembly and slidably mounted to said visor panel, whereby said visor panel may be vertically adjusted along said rod or bar while simultaneously being angularly adjusted relative to said trolley assembly and horizontally adjusted in a substantially orbital path about the user.

20. The device of claim 19, further including a telescoping component in said rod or bar permitting a greater vertical extension of said visor panel for the purpose of blocking lower incident light angles and for accommodating shorter operators.
